(19) United States
(12) Patent Application Publication
(10) Pub. No.: US 2003/0149896 A1
(43) Pub. Date: Aug. 7, 2003

(54) Method and system for securing a data system

(75) Inventors: Willem Pieter Dijkstra, Groningen (NL); Ate Sander Van Steenbergen, Groningen (NL)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONINKLIJKE KPN N.V., GRONINGEN (NL)

(21) Appl. No.: 10/296,352

(22) PCT Filed: Jun. 1, 2001
(86) PCT No.: PCT/EP01/06247

(30) Foreign Application Priority Data
Jun. 7, 2000 (NL) 1015389

(51) Int. Cl. G06F 11/30

(52) U.S. Cl. 713/201

(57) ABSTRACT

Method and system for securing a data system (1) that is connected to other systems by communication means (5) and exchanges data with these other systems via said communication means. The most recently exchanged data is continuously buffered in buffer devices (2, 3). The normal operation of the data system is monitored by a monitoring device (6) that in the event of an abnormality in the operation of the data system activates an output device (7) in order to read out the buffered data from the buffer devices and to make these data available for analysis.

### BACKGROUND OF THE INVENTION

The invention relates to a method for securing a data system that is connected by communication means to other systems and exchanges data with those other systems via said communication means. The invention also relates to a security system for monitoring a data system that exchanges data with other systems via communication means.

Present-day (Internet) security tools can only identify known attacks against a data system. Unknown attacks are not identified and can disrupt services. So-called network sniffers can log all the traffic on a network. As the bandwidths in the networks increase, however, sniffers deliver an enormous quantity of information, which makes it impossible to examine all the sniffed traffic on arrival. “Intrusion Detection Systems” are tools which, on top of a sniffer, attempt in real time to correlate network streams in the search for attacks. Drawbacks: the increased speeds and bandwidths on networks make the deployment of these tools more and more difficult. At gigabit network speeds, there are no systems still able to accomplish this task.

### SUMMARY OF THE INVENTION

The present invention is based on the understanding that only at the moment that a data system malfunctions, for example as a result of a “data attack”, is it important for the last communication with the server to be preserved (comparable to the “black box” in aircraft) This recorded communication can then be used to analyse and ascertain the cause of the malfunctioning and to identify a possible new attack and to secure the data system against it.

The method according to the invention is characterised in that (only) the most recently exchanged data are continuously buffered, the normal operation of the data system is monitored, and (only) in the event of an abnormality in the operation of the data system the buffered data are made available for analysis. A “moving window” is, as it were, placed over the exchanged (incoming and/or outgoing) data stream, the contents of which are not normally processed (analysed). Only after an abnormality has been detected in the operation of the data system being secured are the contents of the moving window preserved so they can be analysed. The invention therefore solves the problem of the large quantity of information and limited analysis time by not performing analysis continuously, but only when necessary.

### EMBODIMENTS

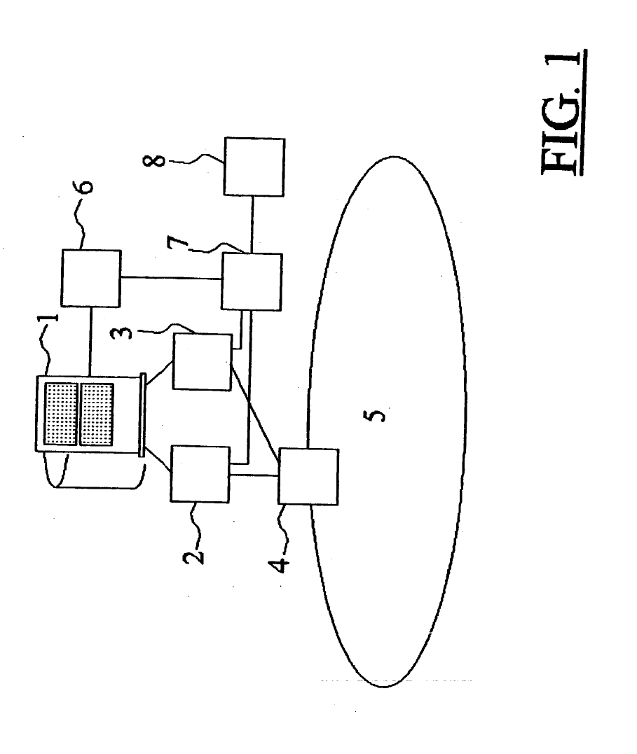

The method according to the invention is illustrated with the aid of FIG. 1. FIG. 1 shows a data system 1, provided with an input buffer device 2 and an output buffer device 3, by means of which the data system 1 connects to the node 4 of a network 5 to which other (data) systems can be connected, with which the data system 1 exchanges data. The data system is secured by buffering the most recently exchanged data in the buffer devices 2 and 3. The normal operation of the data system 1 is monitored in a monitoring device 6. The monitoring device 6 controls an output device 7 such that only in the event of an abnormality in the operation of the data system will the most recent data, buffered in the buffer devices 2 and 3, be called up by the output device 7. The output device 7 may comprise a screen on which, after a fault has occurred in the data system, the data called up from the buffers 2 and 3 can be examined. The output device 7 can also comprise a printer. A “moving window” is, as it were, placed over the exchanged (incoming and/or outgoing) data stream, the contents of which are not normally processed (analysed). Only after an abnormality has been detected in the operation of the data system being secured are the contents of the moving window (in the buffer devices 2 and 3 respectively) preserved so they can be analysed. The data exchanged in the last moments before the occurrence of the fault can be analysed visually by qualified personnel. Alternatively, an analysis system 8 can be used, possibly in addition to the aforementioned method.

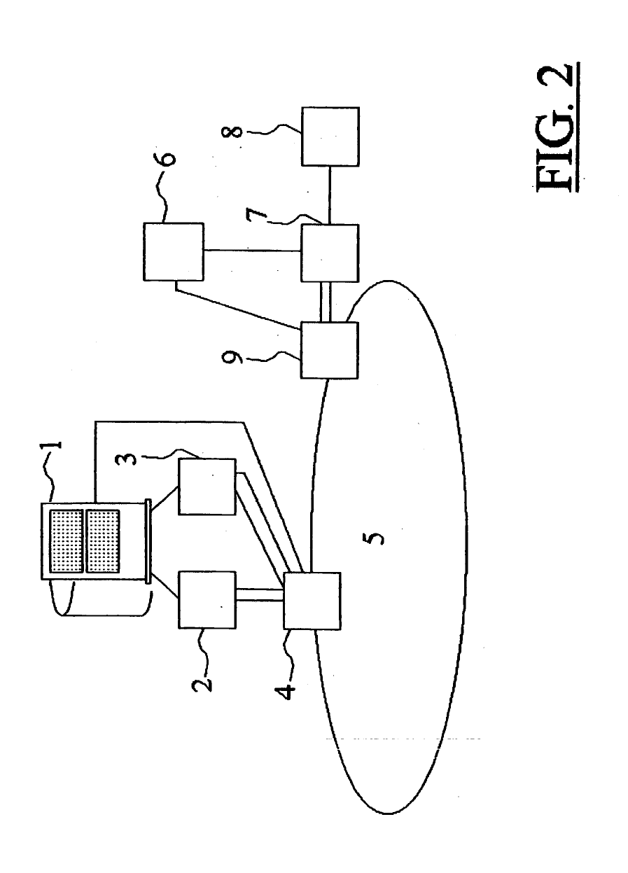

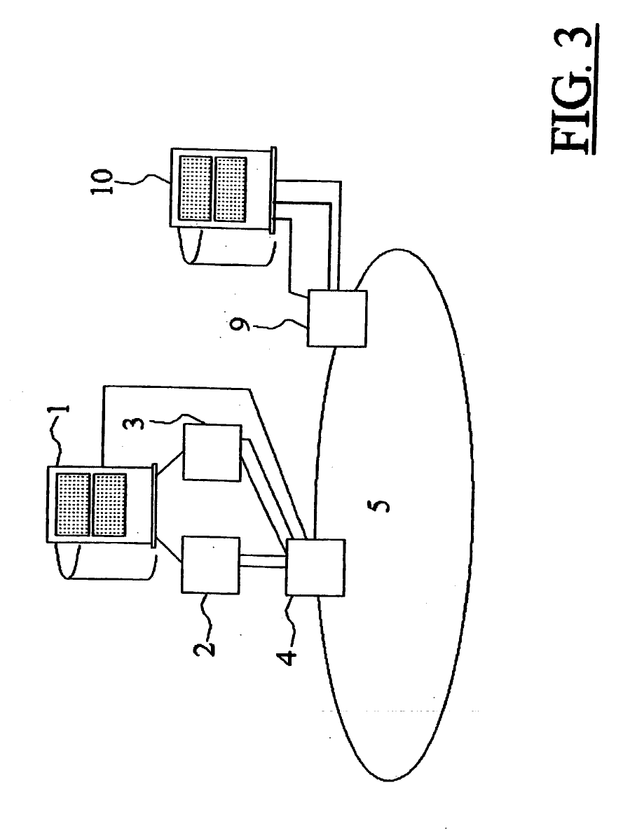

It should be noted that securing the data system 1 can also be achieved remotely, for example via the network 5, as shown in FIG. 2. In FIG. 2 the required connections between the devices 1, 2 and 3 on the one hand and the devices 6 and 7 on the other are accomplished via the network node 4 and a network node 9. These connections are, of course, depending on the network, preferably accomplished by virtual channels. The devices 6, 7 and 8 can form part of a security server 10, as shown in FIG. 3, which can monitor a large number of data systems 1. The behaviour of the data systems 1 to be secured is monitored in real time from security server 10, which receives information from the data systems 1 to be protected. If a data system 1 displays deviant behaviour, the contents of the buffer devices 2 and 3 are “tapped” and examined by the security server, possibly with aid of automated analysis means, such as device 8 in FIG. 2.

It is pointed out that where the above description mentions two buffer devices, 2 and 3, one for incoming data and one for outgoing data, these functions can in practice also be performed by a single input/output buffer. Should a disaster occur in the operation of the data system 1, this I/O buffer will then be read out and the communication data present therein at that moment will be made available to the device 7.

Deviant behaviour of a data system 1 can for example be: a characteristic quantity deviating from its statistical value, a peak load, a continuous very high load, a hard disk becoming full, active processes failing, etc.

The analysis could be used for:

Forensic examination and solving questions of guilt, etc.

Identification of (unknown) “network attacks”; the information thus obtained could then be used to protect the data systems even better.

1. Method for securing a data system that is connected by communication means to other systems and exchanges data with those other systems via said communication means, characterized in that the most recently exchanged data are continuously buffered, the normal operation of the data system is monitored, and in the event of an abnormality in the operation of the data system the buffered data are made available for analysis.

2. Security system for monitoring a data system (1) that exchanges data with other systems via communication means (5), characterized by buffer means (2,3) for the continuous buffering of the data most recently exchanged by the data system and by output means (7) for making the buffered data available.

3. Security system according to claim 2, characterized by monitoring means (6) for monitoring the data system for normal operation and for activating the output means (7) in the event of abnormality in the operation of the data system.

4. Security system according to claim 3, characterized by analysis means (8) for analysing the data made available by the activated output means (7).
